(19) United States
(12) Patent Application Publication
(10) Pub. No.: US 2024/0370575 A1
(43) Pub. Date: Nov. 7, 2024

(54) METHOD FOR CIRCUMVENTING PROCESSOR ERROR INDUCED VULNERABILITY

(71) Applicant: QUALCOMM Incorporated, San Diego, CA (US)

(72) Inventors: Marcel SELHORST, Zeuthen, Brandenburg (DE); Alexander DENT, San Diego, CA (US); Joona Verneri KANNISTO, Salo (FI); Akash VERMA, London (GB)

(21) Appl. No.: 18/691,811

(22) PCT Filed: Aug. 3, 2022
(86) PCT No.: PCT/US2022/039248

§ 371 Date: Mar. 13, 2024

(30) Foreign Application Priority Data
Nov. 23, 2021 (IN) 202141053859

(51) Int. Cl. G06F 21/57

(52) U.S. Cl. CPC G06F 21/577; G06F 2221/034

(57) ABSTRACT

Various embodiments include methods and devices for circumventing processor error induced vulnerability. Embodiments may include determining whether a condition indicative of an error in a processor exists for a first processor, and preventing use of the first processor in response to determining that the condition indicative of the error in the processor exists for the first processor. In some embodiments, preventing use of the first processor may include transitioning the first processor to a low power state. In some embodiments, preventing use of the first processor may include preventing the first processor from being registered with an operating system. In some embodiments, the condition indicative of the error in the processor may include an enabled non-secure debug feature of the processor and a disabled secure debug feature of the processor.

### RELATED APPLICATIONS

This application claims priority to India Provisional Patent Application No. 202141053859 entitled “Method For Circumventing Processor Error Induced Vulnerability” filed Nov. 23, 2021, the entire contents of which are incorporated herein by reference.

### BACKGROUND

Computing device processors, such as a central processing unit (CPU), can be configured with a combination of secure and non-secure operating architectures. A secure operating architecture is configured to restrict access by unauthorized systems and processes to sensitive operations executed and data accesses using the secure operating architecture. However hardware and software flaws can create vulnerabilities that can expose the sensitive operations executed and data accesses using the secure operating architecture.

### SUMMARY

Various aspects of the disclosure include methods and apparatuses for implementing such methods of protecting against a processor error induced vulnerability. Various aspects may include determining whether a condition indicative of an error in a processor exists for a first processor, and preventing use of the first processor in response to determining that the condition indicative of the error in the processor exists for the first processor.

Some aspects may further include reading at least one processor feature state value at a memory location for processor feature states, and comparing the at least one processor feature state value with the condition indicative of the error in the processor.

Some aspects may further include reading at least one processor feature state value at a fuse location for processor feature states, and comparing the at least one processor feature state value with the condition indicative of the error in the processor.

Some aspects may further include reading at least one processor feature state value at a register location for processor feature states, and comparing the at least one processor feature state value with the condition indicative of the error in the processor.

In some aspects, preventing use of the first processor may include transitioning the first processor to a low power state.

In some aspects, preventing use of the first processor may include preventing the first processor from being registered with an operating system.

In some aspects, preventing use of the first processor occurs prior to the first processor executing a process using a non-secure architecture of the first processor.

Some aspects may further include transitioning execution of a process scheduled for execution by the first processor to a second processor.

Some aspects may further include transitioning execution of a process scheduled for execution by the first processor using a non-secure architecture of the first processor to a second processor.

In some aspects, the condition indicative of the error in the processor may include an enabled non-secure debug feature of the processor and a disabled secure debug feature of the processor.

Further aspects include a computing device including a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example system on chip suitable for implementing various embodiments.

FIG. 3 is a process flow diagram illustrating a method for circumventing processor error induced vulnerability according to an embodiment.

FIG. 4 is a process flow diagram illustrating a method for testing for a condition indicative of an error in a processor according to an embodiment.

FIG. 5 is a process flow diagram illustrating a method for testing for a condition indicative of an error in a processor according to an embodiment.

FIG. 6 is a process flow diagram illustrating a method for testing for a condition indicative of an error in a processor according to an embodiment.

FIG. 7 is a process flow diagram illustrating a method for preventing use of a processor according to an embodiment.

FIG. 8 is a process flow diagram illustrating a method for preventing use of a processor according to an embodiment.

FIG. 9 is a component block diagram illustrating an example mobile computing device suitable for implementing various embodiments.

FIG. 10 is a component block diagram illustrating an example mobile computing device suitable for implementing various embodiments.

FIG. 11 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods of circumventing a processor error induced vulnerability. Embodiments may include determining occurrence of a condition indicative of an error in a processor and preventing use of the processor. The condition indicative of the error may be caused in hardware and/or software. Preventing use of the processor may be implemented by various means, such as power collapsing the processor, putting the processor in a sleep state, etc. Detecting an occurrence of a condition indicative of the error in the processor and preventing use of the processor may be implemented prior to the processor executing a process using a non-secure architecture of the processor, such as during a secure boot process.

The term “computing device” may refer to stationary computing devices including personal computers, desktop computers, all-in-one computers, workstations, super computers, mainframe computers, embedded computers (such as in vehicles and other larger systems), computerized vehicles (e.g., partially or fully autonomous terrestrial, aerial, and/or aquatic vehicles, such as passenger vehicles, commercial vehicles, recreational vehicles, military vehicles, drones, etc.), servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

Computing device processors, such as a central processing units (CPU), configured with a combination of secure and non-secure operating architectures can isolate access by unauthorized systems and processes to sensitive operations executed and data accesses using the secure operating architecture. However hardware and software flaws can create vulnerabilities that can expose the sensitive operations executed and data accesses using the secure operating architecture.

As specific and non-limiting example, some architecture processors are designed so that if non-secure invasive debug (or a non-secure debug feature) is enabled and secure invasive debug (or a secure debug feature) is disabled only the non-secure invasive debug state should be available. However, even if secure invasive debug capabilities (or a secure debug feature) are disabled, in a condition of an external debugger and non-secure invasive debug enabled (or a non-secure debug feature is enabled), the secure invasive debug state could be achieved or accessed when the processor is running in the non-secure execution mode and an execution state transition to secure state is triggered. If a processor exhibits such states under such operating conditions, the accessibility of the secure invasive debug state could leave the secure operating architecture of the processor vulnerable to exposure to unauthorized systems and processes.

Leaving the secure operating architecture of the processors vulnerable to exposure to unauthorized systems and processes could allow an attacker to achieve unauthorized access to the sensitive operations executed and data accesses using the secure operating architecture without knowledge by the secure operating architecture. For example, this vulnerability might allow debug processes in the secure operating architecture without the secure operating architecture being informed that debug processes are being implemented. Without knowledge of the unauthorized access, the secure operating architecture processes cannot provide the normal defense mechanisms, such as cryptographic key rotation or clearing of assets in memory. Thus, one condition indicative of vulnerability would be when a non-secure debug feature of the processor is enabled and a secure debug feature of the processor is disabled.

Such vulnerabilities of secure operating architecture of the processors could impact multiple stakeholders. For example, digital rights media (DRM) providers use secure operating architecture of the processors to store secret keys used to decrypt DRM content. A loss of security of those keys could lead to lost revenue for the DRM providers until the key can be blocked and new keys are provisioned to the devices (at which point the cycle might begin again). Further, failure to protect those keys may violate agreements of processor and/or computing device manufacturers to secure such sensitive data. As another example, end-users use secure operating architecture of the processors to store cryptographic keys that are used to protect personal information. A loss of security of those keys could leave end users vulnerable to bad actors using the keys to obtain the protected personal information to extort or impersonate the end-users. Further, failure to protect those keys may have legal implications for processor and/or computing device manufacturers in countries with strict data privacy laws. As another example, processor and/or computing device manufacturers use secure operating architecture of the processors for feature licensing and for Factory Safe Provisioning. A loss of security of the secure operating architecture of the processors could allow a bad actor to maliciously manipulate the capabilities of the processor and/or computing device.

Various embodiments solve the forgoing problems by enabling circumventing situations in which a condition indicative of an error in a processor may leave the secure operating architecture of the processor vulnerable to exposure by preventing use of the processor. In various embodiments, a processor for which a condition indicative of an error in the processor manifests may be configured to be unable to execute code and/or read data. For example, a processor for which a condition indicative of an error in the processor manifests may be power collapsed. As another example, a processor in which the condition indicative of the error manifests may be transitioned to a sleep state.

Various embodiments improve security of computing devices by recognizing conditions indicative of an error in a processor, and taking actions to secure the operating architecture of the processor.

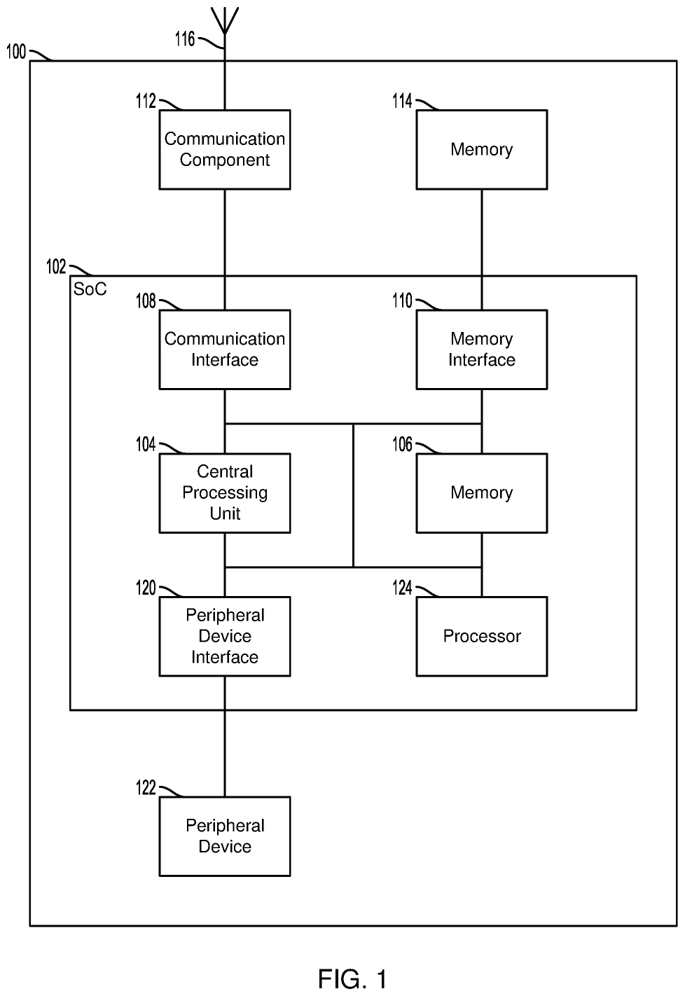

FIG. 1 illustrates a system including a computing device 100 suitable for use with various embodiments. The computing device 100 may include a system-on-chip (SoC) 102 with a central processing unit 104, a memory 106, a communication interface 108, a memory interface 110, a peripheral device interface 120, and a processing device 124. The computing device 100 may further include a communication component 112, such as a wired or wireless modem, a memory 114, an antenna 116 for establishing a wireless communication link, and/or a peripheral device 122. The processor 124 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors and/or processor cores, such as a central processing unit (CPU) 104, and/or processor 124, including a general purpose processor, a central processing unit (CPU) 104, a digital signal processor (DSP), a graphics processing unit (GPU), an accelerated processing unit (APU), a secure processing unit (SPU), an intellectual property unit (IPU), a subsystem processor of specific components of the computing device, such as an image processor for a camera subsystem or a display processor for a display, an auxiliary processor, a peripheral device processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

An SoC 102 may include one or more CPUs 104 and processors 124. The computing device 100 may include more than one SoC 102, thereby increasing the number of CPUs 104, processors 124, and processor cores. The computing device 100 may also include CPUs 104 and processors 124 that are not associated with an SoC 102. Individual CPUs 104 and processors 124 may be multicore processors. The CPUs 104 and processors 124 may each be configured for specific purposes that may be the same as or different from other CPUs 104 and processors 124 of the computing device 100. One or more of the CPUs 104, processors 124, and processor cores of the same or different configurations may be grouped together. A group of CPUs 104, processors 124, or processor cores may be referred to as a multi-processor cluster.

The memory 106 of the SoC 102 may be a volatile or non-volatile memory configured for storing data and processor-executable code for access by the CPU 104, the processor 124, or other components of SoC 102. The computing device 100 and/or SoC 102 may include one or more memories 106 configured for various purposes. One or more memories 106 may include volatile memories such as random-access memory (RAM), including DDR, implemented as main memory or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the CPU 104 and/or processor 124 and temporarily stored for future quick access without being stored in non-volatile memory. The memory 106 may be configured to store data and processor-executable code, at least temporarily, that is loaded to the memory 106 from another memory device, such as another memory 106 or memory 114, for access by one or more of the CPU 104, the processor 124, or other components of SoC 102. In some embodiments, any number and combination of memories 106 may include one-time programmable or read-only memory.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106, such as main memory, in which the memory 114 may store the data or processor-executable code for access by one or more of the CPU 104, the processor 124, or other components of SoC 102. In some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the CPU 104, the processor 124, or other components of the SoC 102 to read data from and write data to the memory 114.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

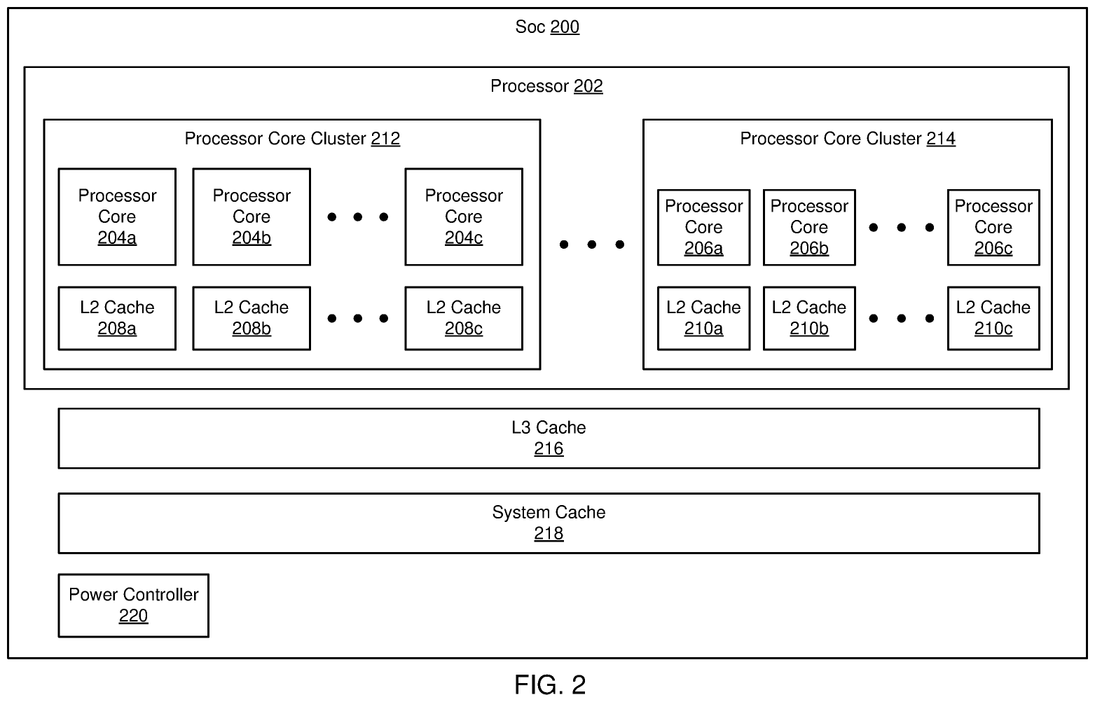

FIG. 2 illustrates an example SoC suitable for implementing various embodiments. With reference to FIGS. 1 and 2 an SoC 200 (e.g., SoC 102 in FIG. 1), may include various combinations of components, including any number and combination of processors 202 (e.g., CPU 104, processor 124 in FIG. 1), an L3 cache 216 (e.g., memory 106 in FIG. 1), a system cache 218 (e.g., memory 106 in FIG. 1), and/or a power controller.

A processor 202 of may include any number and combination of processor cores 204a, 204b, 204c, 206a, 206b, 206c. For example, a multicore processor 202 may have a plurality of homogeneous or heterogeneous processor cores 204a, 204b, 204c, 206a, 206b, 206c. A homogeneous multicore processor may include a plurality of homogeneous processor cores. The processor cores 204a, 204b, 204c, 206a, 206b, 206c may be homogeneous in that, the processor cores 204a, 204b, 204c, 206a, 206b, 206c of the multicore processor 202 may be configured for the same purpose and have the same or similar performance characteristics. For example, the multicore processor 202 may be a general purpose processor, and the processor cores 204a, 204b, 204c, 206a, 206b, 206c may be homogeneous general purpose processor cores. As another example, the multicore processor 202 may be a graphics processing unit or a digital signal processor, and the processor cores 204a, 204b, 204c, 206a, 206b, 206c may be homogeneous graphics processor cores or digital signal processor cores, respectively.

A heterogeneous multicore processor may include a plurality of heterogeneous processor cores. The processor cores 204a, 204b, 204c, 206a, 206b, 206c may be heterogeneous in that the processor cores 204a, 204b, 204c, 206a, 206b, 206c of the multicore processor 202 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores.

Processor cores 204a, 204b, 204c, 206a, 206b, 206c may be grouped together as processor core clusters 212, 214. Generally, processor core clusters 212, 214 may include homogeneous processor cores within each processor core clusters 212, 214. Processor core clusters 212, 214 may be homogeneous or heterogeneous with other processor core clusters 212, 214. For example processor core clusters 212, 214 may be homogeneous having the same processor cores as each other. As another example, processor core clusters 212, 214 may be heterogeneous having the different processor cores from each other. For ease of explanation, the terms “processor,” “processor core,” and “processor core cluster” may be used interchangeably herein.

The processor 202 may further include any number and combination of L2 caches 208a, 208b, 208c, 210a, 210b, 210c (e.g., memory 106 in FIG. 1). For example, each processor core cluster 212, 214 and/or each processor core 204a, 204b, 204c, 206a, 206b, 206c may have a dedicated L2 cache 208a, 208b, 208c, 210a, 210b, 210c. Each L2 cache 208a, 208b, 208c, 210a, 210b, 210c may be designated for read and/or write access by a designated processor core cluster 212, 214 and/or processor core 204a, 204b, 204c, 206a, 206b, 206c. The L2 cache 208a, 208b, 208c, 210a, 210b, 210c may store data and/or instructions, and make the stored data and/or instructions available to the designated processor core cluster 212, 214 and/or processor core 204a, 204b, 204c, 206a, 206b, 206c. The L2 caches 208a, 208b, 208c, 210a, 210b, 210c may include volatile memory as described herein with reference to memory 16 of FIG. 1.

The L3 cache 216 and the system cache 218 may be shared by and configured for read and/or write access by the processor core clusters 212, 214 and/or the processor cores 204a, 204b, 204c, 206a, 206b, 206c. The L3 cache 216 and the system cache 218 may store data and/or instructions, and make the stored data and/or instructions available to the processor core clusters 212, 214 and/or the processor cores 204a, 204b, 204c, 206a, 206b, 206c. The L3 cache 216 and/or the system cache 218 may function as a buffer for data and/or instructions input to and/or output from the processor 202. The L3 cache 216 and the system cache 218 may include volatile memory as described herein with reference to memory 16 of FIG. 1.

The processor 202 may further include any number and combination of power controllers 202, such as one or more power management integrated circuits (PMIC). A power controller 202 may be configured to control an amount of power provided to any number and combination of the processor core clusters 212, 214 and/or the processor cores 204a, 204b, 204c, 206a, 206b, 206c. The power provided to a processor core cluster 212, 214 and/or a processor core 204a, 204b, 204c, 206a, 206b, 206c, as controlled by the power controller 202, may be determined by a state of the processor core cluster 212, 214 and/or the processor core 204a, 204b, 204c, 206a, 206b, 206c. For decreasingly lower power states, the power controller 202 may control providing decreasingly lower power. For example, for a sleep state of the processor core cluster 212, 214 and/or the processor core 204a, 204b, 204c, 206a, 206b, 206c, the power controller 202 may control providing less power than for an awake state. As another example, for a power collapse or off state of the processor core cluster 212, 214 and/or the processor core 204a, 204b, 204c, 206a, 206b, 206c, the power controller 202 may control providing less power than for the sleep state, including as little as nominal or no power.

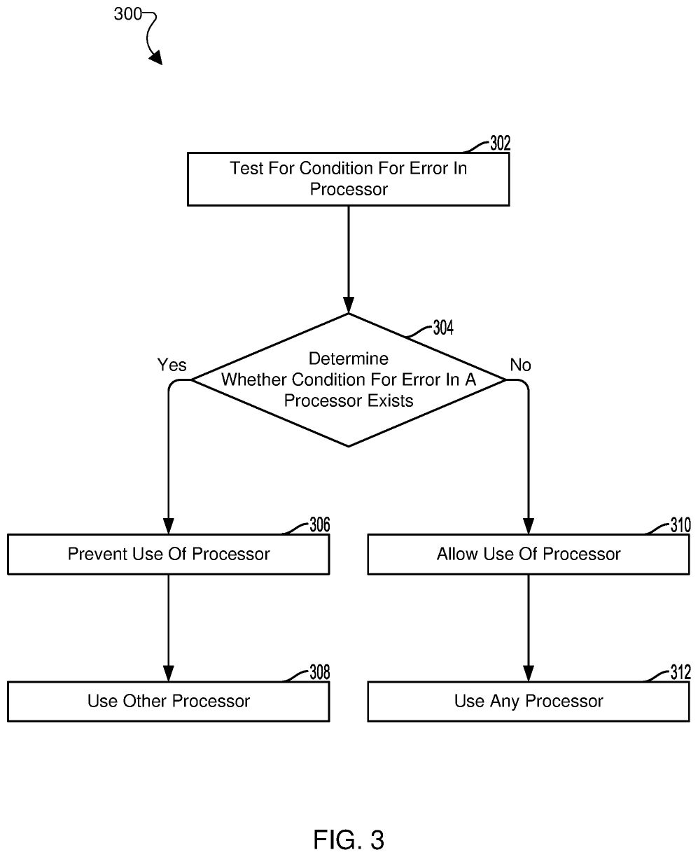

FIG. 3 illustrates a method 300 for circumventing a processor error induced vulnerability according to some embodiments. With reference to FIGS. 1-3, the method 300 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 300 is referred to herein as a “processing device.”

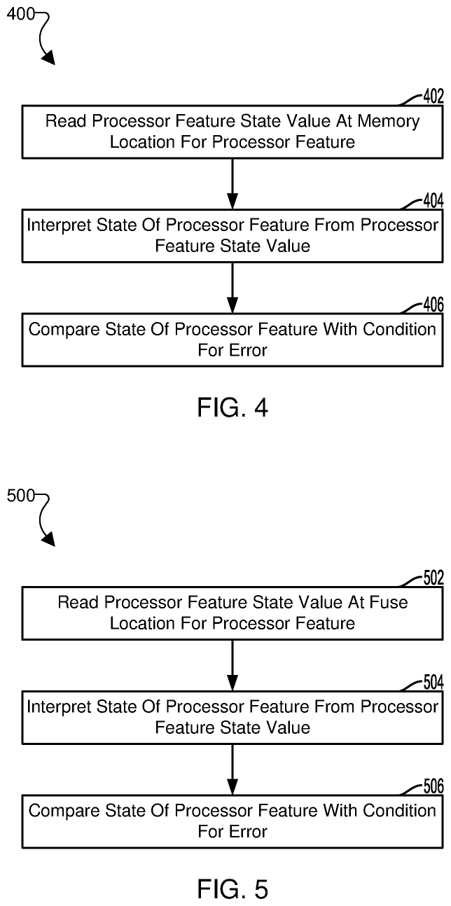

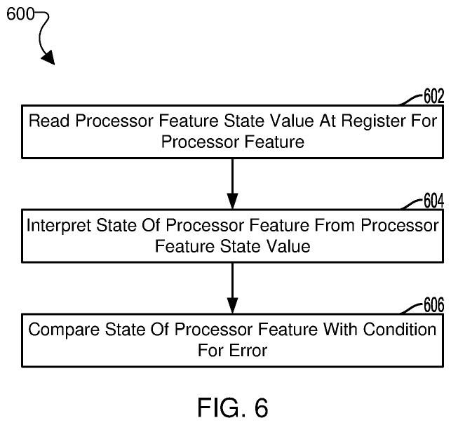

In block 302, the processing device may test for a condition indicative of an error in a processor (e.g., CPU 104, processor 124 in FIG. 1, processor 202, processor core 204a, 204b, 204c, 206a, 206b, 206c, processor core cluster 212, 214 in FIG. 2). The condition indicative of the error may be caused in hardware and/or software, and may leave a secure operating architecture of the processor vulnerable to unauthorized access by unauthorized systems and/or processes to sensitive operations executed by and/or data accesses using the secure operating architecture. The processing device may be preconfigured with code for implementing any number and combination of tests for a known condition indicative of the error in the processor. The test for the condition indicative of the error in the processor may be implemented prior to the processor executing operations by and/or accessing data using a non-secure operating architecture of the processor. For example, the test for the condition indicative of the error in the processor may be implemented during a boot process executed using the secure operating architecture of the processor. The test for the condition indicative of the error in the processor may be implemented by the processor itself and/or by a different processor (e.g., CPU 104, processor 124 in FIG. 1, processor 202, processor core 204a, 204b, 204c, 206a, 206b, 206c, processor core cluster 212, 214 in FIG. 2). For example, the processing device may implement the test for the condition indicative of the error in the processing device itself. As another example, the processing device may implement the test for the condition indicative of the error in a processor. As another example, the processing device may check whether a non-secure debug feature of the processor is enabled and/or whether a secure debug feature of the processor is disabled. Examples of tests for the condition indicative of the error in the processor are described further herein for method 400 with reference to FIG. 4, for method 500 with reference to FIG. 5, and for method 600 with reference to FIG. 6. In some embodiments, the processing device testing for the condition indicative of the error in the processor in block 302 may be a processor (e.g., CPU 104, processor 124 in FIG. 1, processor 202, processor core 204a, 204b, 204c, 206a, 206b, 206c, processor core cluster 212, 214 in FIG. 2).

In determination block 304, the processing device may determine whether the condition indicative of the error in the processor exists. As discussed above, the test for the condition indicative of the error in the processor may be a known condition. The processing device may interpret the result to determine whether the condition indicative of the error in the processor exists. For example, the result may be a signal generated by the processing device configured to indicate whether the condition indicative of the error in the processor exists. As another example, the result may be a value stored to a memory location, register, buffer, etc. (e.g., memory 106, memory 114 in FIG. 1, L2 cache 208a, 208b, 208c, 210a, 210b, 210c, L3 cache 216, system cache 218 in FIG. 2) by the processing device with the value configured to indicate to the processing device whether the condition indicative of the error in the processor exists. In some embodiments the processing device may determine whether the condition indicative of an error in the processor exists by determining whether an enabled non-secure debug feature of the first processor and a disabled secure debug feature of the first processor exists. Based on an interpretation of the result of the test for the condition indicative of the error, the processing device may determine whether the condition indicative of the error in the processor exists. Determining whether the condition indicative of the error in the processor exists may be implemented prior to the processor executing operations by and/or accessing data using a non-secure operating architecture of the processor. In some embodiments, the processing device determining whether the condition indicative of the error in the processor exists in determination block 304 may be a processor (e.g., CPU 104, processor 124 in FIG. 1, processor 202, processor core 204a, 204b, 204c, 206a, 206b, 206c, processor core cluster 212, 214 in FIG. 2).

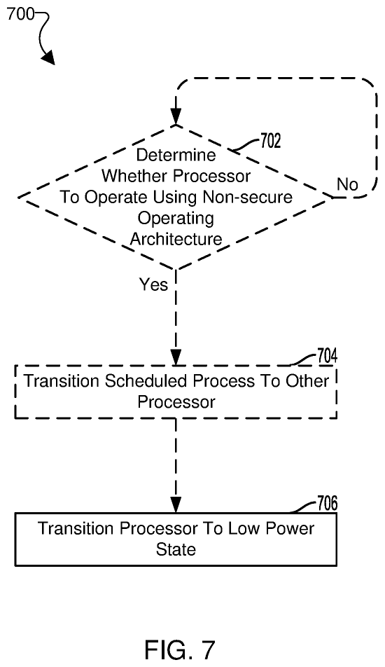

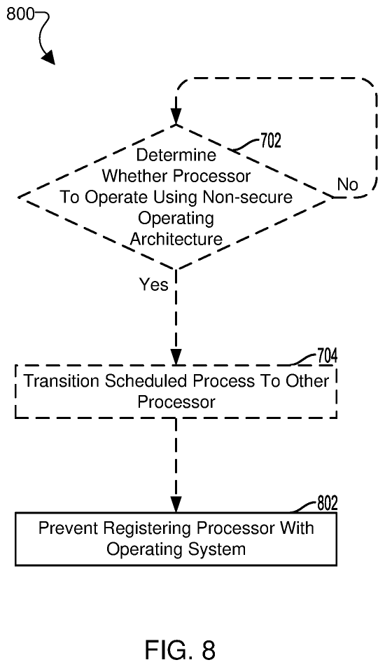

In response to determining that the condition indicative of the error in the processor exists (i.e., determination block 304=“Yes”), the processing device may prevent use of the processor exhibiting the condition indicative of the error in the processor in block 306. Preventing use of the processor may include disabling the processor from being able to execute operations and/or data accesses. For example, the processing device may cause a transition of the processor to a state for which the processor is not able to execute operations and/or data accesses. Preventing use of the processor may be implemented prior to the processor executing operations by and/or accessing data using a non-secure operating architecture of the processor. Preventing use of the processor may be implemented by the processor itself and/or by a different processor (e.g., CPU 104, processor 124 in FIG. 1, processor 202, processor core 204a, 204b, 204c, 206a, 206b, 206c, processor core cluster 212, 214 in FIG. 2). For example, the processing device may implement mechanisms to prevent use of a processor for which the condition indicative of the error exists. Preventing use of the processor exhibiting the condition indicative of the error in the processor may include making the processor invisible or unavailable to components of the computing device. Examples of preventing use of the processor exhibiting the condition indicative of the error in the processor are described further in method 700 with reference to FIG. 7 and in method 800 with reference to FIG. 8. In some embodiments, the processing device preventing use of the processor exhibiting the condition indicative of the error in the processor in block 306 may be a processor (e.g., CPU 104, processor 124 in FIG. 1, processor 202, processor core 204a, 204b, 204c, 206a, 206b, 206c, processor core cluster 212, 214 in FIG. 2) and/or a power controller (e.g., power controller 220 in FIG. 2).

In block 308, the processing device may configure another processor (e.g., CPU 104, processor 124 in FIG. 1, processor 202, processor core 204a, 204b, 204c, 206a, 206b, 206c, processor core cluster 212, 214 in FIG. 2) for use instead of the processor exhibiting the condition indicative of the error in the processor. The processor exhibiting the condition indicative of the error in the processor may be designated for implementing certain operation executions and/or data accesses. In particular, the processor exhibiting the condition indicative of the error in the processor may be designated for implementing certain operation executions and/or data accesses using, but not limited to, the non-secure architecture of the processor exhibiting the condition. For example, the processor may be designated for implementing applications using the non-secure architecture of the processor during normal operation of the computing device. The other processor may be a processor not exhibiting the condition indicative of a processor error. The other processor may be designated for implementing certain operation executions and/or data accesses using, but not limited to, the non-secure architecture of the other processor for the given condition and/or another given condition. For example, the other processor may be designated for implementing applications using the non-secure architecture of the other processor during normal operation of the computing device. As another example, the other processor may be designated for implementing applications using the non-secure architecture of the other processor during abnormal operation of the computing device, such as during higher workloads than during normal operation of the computing device. Configuring the other processor for use instead of the processor exhibiting the condition indicative of the error in the processor may include configuring the other processor to be designated for implementing certain operation executions and/or data accesses for which the processor was designated. In particular, the other processor may be configured to be designated for implementing certain operation executions and/or data accesses using, but not limited to, the non-secure architecture of the other processor for the given condition as the processor was designated. For example, the other processor may be configured to be designated for implementing applications using the non-secure architecture of the other processor during normal operation of the computing device as the processor was designated. Configuring the other processor for use instead of the processor exhibiting the condition indicative of the error in the processor may be implemented by the processor, the other processor itself, and/or by a different processor (e.g., CPU 104, processor 124 in FIG. 1, processor 202, processor core 204a, 204b, 204c, 206a, 206b, 206c, processor core cluster 212, 214 in FIG. 2). For example, the processing device may configure the processing device itself for use as the other processor. As another example, the processing device may configure the other processor for use. In some embodiments, the processing device configuring the other processor for use instead of the processor exhibiting the condition indicative of the error in the processor in block 308 may be a processor (e.g., CPU 104, processor 124 in FIG. 1, processor 202, processor core 204a, 204b, 204c, 206a, 206b, 206c, processor core cluster 212, 214 in FIG. 2).

In response to determining that the condition indicative of the error in the processor does not exists (i.e., determination block 304=“No”), the processing device may allow use of the processor in block 310. In block 312, the processing device may configure any processor (e.g., CPU 104, processor 124 in FIG. 1, processor 202, processor core 204a, 204b, 204c, 206a, 206b, 206c, processor core cluster 212, 214 in FIG. 2) for use. The processing device allowing use of the processor in block 310 and configuring any processor for use in block 312 may be a processor (e.g., CPU 104, processor 124 in FIG. 1, processor 202, processor core 204a, 204b, 204c, 206a, 206b, 206c, processor core cluster 212, 214 in FIG. 2) and/or power controller (e.g., power controller 220 in FIG. 2).

FIG. 4 illustrates a method 400 for testing for a condition indicative of an error in a processor according to some embodiments. With reference to FIGS. 1-4, the method 400 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 400 is referred to herein as a “processing device.” Blocks 402-406 may further describe operations that may be performed in block 302 of the method 300 described with reference to FIG. 3.

In block 402, the processing device may read a processor feature state value at a memory location for the processor feature. The processor feature state value may be a value associated with a processor feature and may be configured to indicate a state of the processor feature to the processing device. For example, the processor feature state value may indicate to the processing device whether the processor feature is enabled or disabled. The processor feature state value may be stored at a memory (e.g., memory 106, memory 114 in FIG. 1, L2 cache 208a, 208b, 208c, 210a, 210b, 210c, L3 cache 216, system cache 218 in FIG. 2), such as cache location, a register, a buffer, etc. and accessed by the processing device. The processing device may read any number and combination of processor feature state values at memory locations for processor features. The processing device reading the processor feature state value at the memory location for the processor feature in block 402 may be a processor (e.g., CPU 104, processor 124 in FIG. 1, processor 202, processor core 204a, 204b, 204c, 206a, 206b, 206c, processor core cluster 212, 214 in FIG. 2).

In block 404, the processing device may interpret the state of the processor feature from the processor feature state value. For example, the memory location of the processor feature state value may be associated with the processor feature, and the processing device may interpret the processor feature state from the memory location. The processor feature state value at the memory location may indicate to the processing device the state of the processor feature associated with memory location. For example, a value of “1” may indicate to the processing device that the processor feature is enabled and a value of “0” may indicate to the processing device that the processor feature is disabled, or vice versa. Any number and combination of processor feature state values may be interpreted by the processing device. For example, multiple and/or combinations of processor feature state values may be combined, converted, and/or simplified to interpret the state of the multiple and/or combinations of processor features. The processing device interpreting the state of the processor feature from the processor feature state value in block 404 may be a processor (e.g., CPU 104, processor 124 in FIG. 1, processor 202, processor core 204a, 204b, 204c, 206a, 206b, 206c, processor core cluster 212, 214 in FIG. 2).

In block 406, the processing device may compare the state of processor feature with the condition indicative of the error in a processor (e.g., CPU 104, processor 124 in FIG. 1, processor 202, processor core 204a, 204b, 204c, 206a, 206b, 206c, processor core cluster 212, 214 in FIG. 2). One or more states of processor features may be known as a condition indicative of the error in the processor. The processing device may compare the interpreted processor feature state value to the condition, which may be represented as a similar formatted value. For example, a comparison of the interpreted processor feature state value and the condition may result in a value configured to indicate to the processing device whether the condition indicative of the error in the processor exists. The result of the comparison may be used by the processing device to determine whether the condition indicative of the error in the processor exists in determination block 304 of the method 300 as described with reference to FIG. 3. The processing device comparing the state of processor feature with the condition indicative of the error in a processor in block 406 may be a processor (e.g., CPU 104, processor 124 in FIG. 1, processor 202, processor core 204a, 204b, 204c, 206a, 206b, 206c, processor core cluster 212, 214 in FIG. 2).

FIG. 5 illustrates a method 500 for testing for a condition indicative of an error in a processor according to some embodiments. With reference to FIGS. 1-5, the method 500 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 500 is referred to herein as a “processing device.” Blocks 502, 504, and 406 may further describe operations that may be performed in block 302 of the method 300 described with reference to FIG. 3.

In block 502, the processing device may read a processor feature state value at a fuse location for the processor feature. The processor feature state value may be a value associated with a processor feature and may be configured to indicate a state of the processor feature to the processing device. For example, the processor feature state value may indicate to the processing device whether the processor feature is enabled or disabled. The processor feature state value may be based on a signal that may be transmitted via a fuse of a processor (e.g., CPU 104, processor 124 in FIG. 1, processor 202, processor core 204a, 204b, 204c, 206a, 206b, 206c, processor core cluster 212, 214 in FIG. 2). The processing device may successfully read a signal transmitted via the fuse when the fuse is closed. The processing device may fail reading a signal not transmitted via the fuse when the fuse is open. The processing device may read any number and combination of processor feature state values at fuse locations for processor features. The processing device reading the processor feature state value at the fuse location for the processor feature in block 502 may be a processor (e.g., CPU 104, processor 124 in FIG. 1, processor 202, processor core 204a, 204b, 204c, 206a, 206b, 206c, processor core cluster 212, 214 in FIG. 2).

In block 504, the processing device may interpret the state of the processor feature from the processor feature state value. For example, the fuse location of the processor feature state value may be associated with the processor feature, and the processing device may interpret the processor feature state read from the fuse location. The processor feature state value read at the fuse location may indicate to the processing device the state of the processor feature associated with memory location. For example, a value of “1” read at a fuse location of a closed fuse may indicate to the processing device that the processor feature is enabled and a value of “0” read at a fuse location of an open fuse may indicate to the processing device that the processor feature is disabled, or vice versa. Any number and combination of processor feature state values may be interpreted by the processing device. For example, multiple and/or combinations of processor feature state values may be combined, converted, and/or simplified to interpret the state of the multiple and/or combinations of processor features. The processing device interpreting the state of the processor feature from the processor feature state value in block 504 may be a processor (e.g., CPU 104, processor 124 in FIG. 1, processor 202, processor core 204a, 204b, 204c, 206a, 206b, 206c, processor core cluster 212, 214 in FIG. 2).

In block 506, the processing device may compare the state of a processor feature with the condition indicative of the error in a processor (e.g., CPU 104, processor 124 in FIG. 1, processor 202, processor core 204a, 204b, 204c, 206a, 206b, 206c, processor core cluster 212, 214 in FIG. 2). One or more states of processor features may be known as a condition or conditions indicative of the error in the processor. The processing device may compare the interpreted processor feature state value to the condition, which may be represented as a similar formatted value. For example, a comparison of the interpreted processor feature state value and the condition may result in a value configured to indicate to the processing device whether the condition indicative of the error in the processor exists. The result of the comparison may be used to determine whether the condition indicative of the error in the processor exists in determination block 304 of the method 300 described with reference to FIG. 3. The processing device comparing the state of processor feature with the condition indicative of the error in a processor in block 506 may be a processor (e.g., CPU 104, processor 124 in FIG. 1, processor 202, processor core 204a, 204b, 204c, 206a, 206b, 206c, processor core cluster 212, 214 in FIG. 2).

FIG. 6 illustrates a method 600 for testing for a condition indicative of an error in a processor according to some embodiments. With reference to FIGS. 1-6, the method 600 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 400 is referred to herein as a “processing device.” Blocks 602-606 may further describe operations that may be performed in block 302 of the method 300 described with reference to FIG. 3.

In block 602, the processing device may read a processor feature state value at a register location for the processor feature. The processor feature state value may be a value associated with a processor feature and may be configured to indicate a state of the processor feature to the processing device. For example, the processor feature state value may indicate to the processing device whether the processor feature is enabled or disabled. The processor feature state value may be stored at a register (e.g., memory 106, memory 114 in FIG. 1, L2 cache 208a, 208b, 208c, 210a, 210b, 210c, L3 cache 216, system cache 218 in FIG. 2) and accessed by the processing device. The processing device may read any number and combination of processor feature state values at register locations for processor features. The processing device reading the processor feature state value at the register location for the processor feature in block 602 may be a processor (e.g., CPU 104, processor 124 in FIG. 1, processor 202, processor core 204a, 204b, 204c, 206a, 206b, 206c, processor core cluster 212, 214 in FIG. 2).

In block 604, the processing device may interpret the state of the processor feature from the processor feature state value. For example, the register location of the processor feature state value may be associated with the processor feature, and the processing device may interpret the processor feature state from the register location. The processor feature state value at the memory location may indicate to the processing device the state of the processor feature associated with register location. For example, a value of “1” may indicate to the processing device that the processor feature is enabled and a value of “0” may indicate to the processing device that the processor feature is disabled, or vice versa. Any number and combination of processor feature state values may be interpreted by the processing device. For example, multiple and/or combinations of processor feature state values may be combined, converted, and/or simplified to interpret the state of the multiple and/or combinations of processor features. The processing device interpreting the state of the processor feature from the processor feature state value in block 604 may be a processor (e.g., CPU 104, processor 124 in FIG. 1, processor 202, processor core 204a, 204b, 204c, 206a, 206b, 206c, processor core cluster 212, 214 in FIG. 2).

In block 606, the processing device may compare the state of a processor feature with the condition indicative of the error in a processor (e.g., CPU 104, processor 124 in FIG. 1, processor 202, processor core 204a, 204b, 204c, 206a, 206b, 206c, processor core cluster 212, 214 in FIG. 2). One or more states of processor features may be known to be a condition indicative of the error in the processor. The processing device may compare the interpreted processor feature state value to the condition, which may be represented as a similar formatted value. For example, a comparison of the interpreted processor feature state value and the condition may result in a value configured to indicate to the processing device whether the condition indicative of the error in the processor exists. The result of the comparison may be used by the processing device to determine whether the condition indicative of the error in the processor exists in determination block 304 of the method 300 as described with reference to FIG. 3. The processing device comparing the state of processor feature with the condition indicative of the error in a processor in block 606 may be a processor (e.g., CPU 104, processor 124 in FIG. 1, processor 202, processor core 204a, 204b, 204c, 206a, 206b, 206c, processor core cluster 212, 214 in FIG. 2).

FIG. 7 illustrates a method 700 for preventing use of a processor according to some embodiments. With reference to FIGS. 1-7, the method 700 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 700 is referred to herein as a “processing device.” Blocks 702-706 may further describe operations that may be performed in block 306 of the method 300 described with reference to FIG. 3.

In optional determination block 702, the processing device may determine whether a processor (e.g., CPU 104, processor 124 in FIG. 1, processor 202, processor core 204a, 204b, 204c, 206a, 206b, 206c, processor core cluster 212, 214 in FIG. 2) is designated to operate using the non-secure operating architecture of the processor. The processor may be designated for implementing certain operation executions and/or data accesses using, but not limited to, non-secure operating architecture of the processor. For example, the other processor may be configured to be designated for implementing applications using the non-secure architecture of the other processor during normal operation of the computing device as the processor was designated. The processing device may determine whether the processor is designated to operate using non-secure operating architecture of the processor by any number and combination of manners. For example, the processing device may determine whether the processor is designated to operate using non-secure operating architecture of the processor by a state of the processor, a priority, rank, or classification of the processor, scheduled operations for the processor, etc. The processing device determining whether the processor is designated to operate using non-secure operating architecture of the processor in optional determination block 702 may be a processor (e.g., CPU 104, processor 124 in FIG. 1, processor 202, processor core 204a, 204b, 204c, 206a, 206b, 206c, processor core cluster 212, 214 in FIG. 2).

In response to determining that the processor is not designated to operate using non-secure operating architecture of the processor (optional determination block 702=“No”), the processing device may determine whether the processor is designated to operate using non-secure operating architecture of the processor in optional determination block 702.

In response to or independent of determining that the processor is designated to operate using non-secure operating architecture of the processor (optional determination block 702=“Yes”), the processing device may transition a scheduled process to another processor (e.g., CPU 104, processor 124 in FIG. 1, processor 202, processor core 204a, 204b, 204c, 206a, 206b, 206c, processor core cluster 212, 214 in FIG. 2) in optional block 704. The processor designated to operate using non-secure operating architecture may be executing and/or scheduled to execute an operation and/or a data access. In an example, the processing device may transition the executing and/or the scheduled operation and/or data access to the other processor, which may be a processor for which a condition indicative of a processor error does not exist. The processing device may transition the executing and/or the scheduled operation and/or data access to the other processor regardless of whether the executing and/or the scheduled operation and/or data access are executing using and/or scheduled to use the non-secure architecture of the processor. In another example, the processing device may transition the scheduled operation and/or data access to the other processor in response to being scheduled to use the non-secure architecture of the processor. Transitioning the scheduled process to the other processor may be implemented prior to the processor executing operations by and/or accessing data using a non-secure operating architecture of the processor. The processing device transitioning the scheduled process to the other processor in optional block 704 may be a processor (e.g., CPU 104, processor 124 in FIG. 1, processor 202, processor core 204a, 204b, 204c, 206a, 206b, 206c, processor core cluster 212, 214 in FIG. 2).

In block 706, the processing device may transition the processor exhibiting the condition indicative of the error in the processor to a low power state. The processing device may signal to a power controller (e.g., power controller 202) to reduce power provide to the processor, and the power controller may respond by reducing the power provided to the processor. For example, the low power state may be a sleep state of the processor and the power controller 202 may control providing less power than for an awake state. As another example, the low power state may be a power collapse or off state of the processor and the power controller 202 may control providing less power than for the sleep state, including as little as nominal or no power. Transitioning the processor to the low power state may make the processor unable to execute operations and/or data accesses. Transitioning the processor to a low power state may make the processor invisible or unavailable to components of the computing device. Transitioning the processor to the low power state may be implemented prior to the processor executing operations by and/or accessing data using a non-secure operating architecture of the processor. In some embodiments, the processing device transitioning the processor exhibiting the condition indicative of the error in the processor to the low power state in block 706 may be a processor (e.g., CPU 104, processor 124 in FIG. 1, processor 202, processor core 204a, 204b, 204c, 206a, 206b, 206c, processor core cluster 212, 214 in FIG. 2).

FIG. 8 illustrates a method 800 for preventing use of a processor according to some embodiments. With reference to FIGS. 1-8, the method 800 may be implemented in a computing device (e.g., computing device 100 in FIG. 1), in hardware (e.g., power controller 220 in FIG. 2), in software executing in a processor (e.g., CPU 104, processor 124 in FIG. 1, processor 202, processor core 204a, 204b, 204c, 206a, 206b, 206c, processor core cluster 212, 214, power controller 220 in FIG. 2), or in a combination of a software-configured processor and dedicated hardware that includes other individual components, such as various memories/caches (e.g., memory 106, memory 114 in FIG. 1, L2 cache 208a, 208b, 208c, 210a, 210b, 210c, L3 cache 216, system cache 218 in FIG. 2) and various memory/cache controllers. In order to encompass the alternative configurations enabled in various embodiments, the hardware implementing the method 800 is referred to herein as a “processing device.” Blocks 702, 704, 802 may further describe operations that may be performed in block 306 of the method 300 described with reference to FIG. 3. Blocks 702 and 704 may be implemented as described herein for the method 700 with reference to FIG. 7.

In block 802, the processing device may prevent a processor (e.g., CPU 104, processor 124 in FIG. 1, processor 202, processor core 204a, 204b, 204c, 206a, 206b, 206c, processor core cluster 212, 214, power controller 220 in FIG. 2) for which the condition indicative of the error in the processor exists from being registered with an operating system of the computing device. Preventing the processor from being registered with the operating system may make the processor unable to execute operations and/or data accesses. Preventing the processor from being registered with the operating system invisible or unavailable to components of the computing device. Preventing the processor from being registered with the operating system may be implemented prior to the processor executing operations by and/or accessing data using a non-secure operating architecture of the processor. In some embodiments, the processing device preventing the processor exhibiting the condition indicative of the error in the processor from being registered with an operating system of the computing device in block 802 may be a processor (e.g., CPU 104, processor 124 in FIG. 1, processor 202, processor core 204a, 204b, 204c, 206a, 206b, 206c, processor core cluster 212, 214 in FIG. 2).

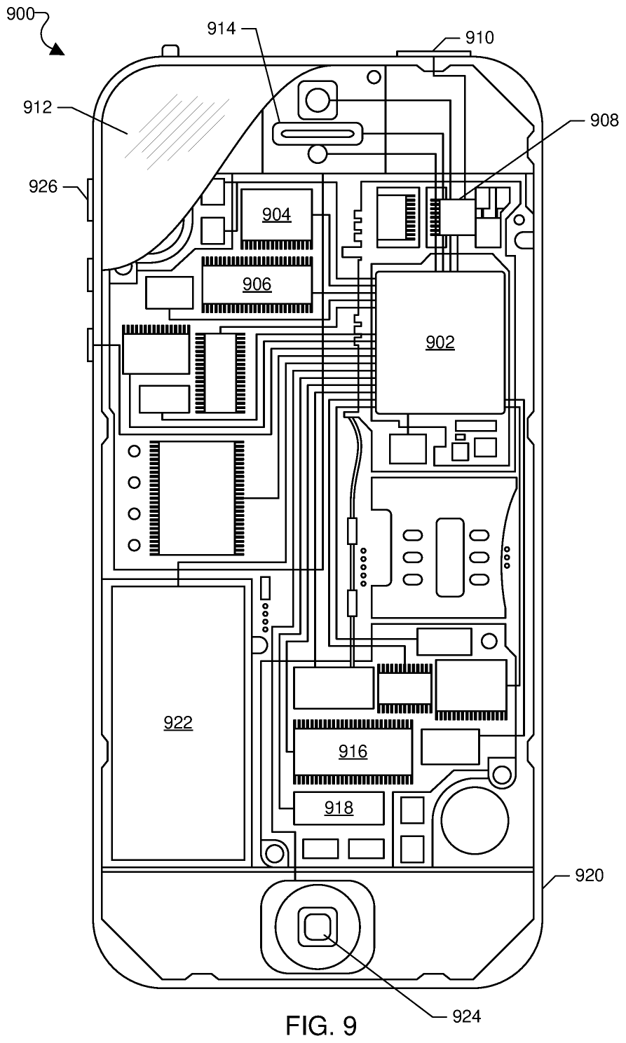

A system in accordance with the various embodiments (including, but not limited to, embodiments described above with reference to FIGS. 1-8) may be implemented in a wide variety of computing systems including mobile computing devices, an example of which suitable for use with the various embodiments is illustrated in FIG. 9. The mobile computing device 900 may include a processor 902 coupled to a touchscreen controller 904 and an internal memory 906. The processor 902 may be one or more multicore integrated circuits designated for general or specific processing tasks. The internal memory 906 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile computing device 900 need not have touch screen capability.

The mobile computing device 900 may have one or more radio signal transceivers 908 (e.g., Peanut, Bluetooth, ZigBee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor.

The mobile computing device 900 may include a peripheral device connection interface 918 coupled to the processor 902. The peripheral device connection interface 918 may be singularly configured to accept one type of connection, or may be configured to accept various types of physical and communication connections, common or proprietary, such as Universal Serial Bus (USB), FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components described herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

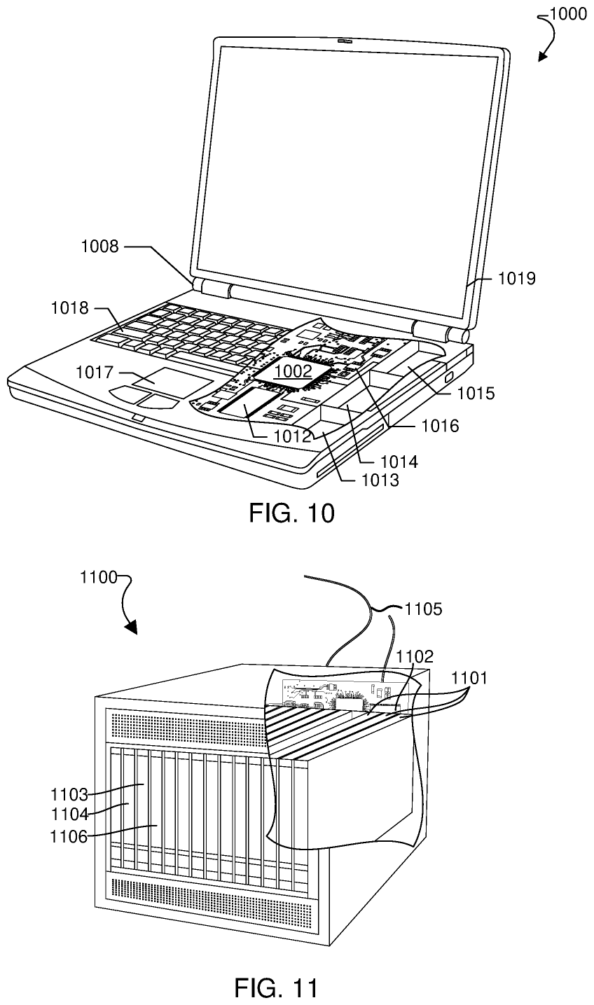

A system in accordance with the various embodiments (including, but not limited to, embodiments described above with reference to FIGS. 1-8) may be implemented in a wide variety of computing systems include a laptop computer 1000 an example of which is illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1002 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1002. The computer 1000 may also include a floppy disc drive 1014 and a compact disc (CD) drive 1015 coupled to the processor 1002. In a notebook configuration, the computer housing includes the touchpad 1017, the keyboard 1018, and the display 1019 all coupled to the processor 1002. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-8) may also be implemented in fixed computing systems, such as any of a variety of commercially available servers. An example server 1100 is illustrated in FIG. 11. Such a server 1100 typically includes one or more multicore processor assemblies 1101 coupled to volatile memory 1102 and a large capacity nonvolatile memory, such as a disk drive 1104. As illustrated in FIG. 11, multicore processor assemblies 1101 may be added to the server 1100 by inserting them into the racks of the assembly. The server 1100 may also include a floppy disc drive, compact disc (CD) or digital versatile disc (DVD) disc drive 1106 coupled to the processor 1101. The server 1100 may also include network access ports 1103 coupled to the multicore processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a computing device comprising a processing device configured with processing device-executable instructions to perform operations of the example systems, devices, or methods; the example systems, devices, or methods discussed in the following paragraphs implemented by a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

Example 1. A method for protecting against a processor error induced vulnerability may include determining whether a condition indicative of an error in a processor exists for a first processor, and preventing use of the first processor in response to determining that the condition indicative of the error in the processor exists for the first processor.

Example 2. The method of example 1, further including reading at least one processor feature state value at a memory location for processor feature states, and comparing the at least one processor feature state value with the condition indicative of the error in the processor.

Example 3. The method of example 1, further including reading at least one processor feature state value at a fuse location for processor feature states, and comparing the at least one processor feature state value with the condition indicative of the error in the processor.

Example 4. The method of example 1, further including reading at least one processor feature state value at a register location for processor feature states, and comparing the at least one processor feature state value with the condition indicative of the error in the processor.

Example 5. The method of any of examples 1-4, in which preventing use of the first processor includes transitioning the first processor to a low power state.

Example 6. The method of any of examples 1-5, in which preventing use of the first processor includes preventing the first processor from being registered with an operating system.

Example 7. The method of any of examples 1-6, in which preventing use of the first processor occurs prior to the first processor executing a process using a non-secure architecture of the first processor.

Example 8. The method of any of examples 1-7, further including transitioning execution of a process scheduled for execution by the first processor to a second processor.

Example 9. The method of any of examples 1-7, further including transitioning execution of a process scheduled for execution by the first processor using a non-secure architecture of the first processor to a second processor.

Example 10. The method of any of examples 1-9, in which determining whether a condition indicative of an error in a processor exists for the first processor includes determining whether an enabled non-secure debug feature of the first processor and a disabled secure debug feature of the first processor exists.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for protecting against a processor error induced vulnerability, comprising:
determining whether a condition indicative of an error in a processor exists for a first processor; and
preventing use of the first processor in response to determining that the condition indicative of the error in the processor exists for the first processor.

2. The method of claim 1, further comprising:
reading at least one processor feature state value at a memory location for processor feature states; and
comparing the at least one processor feature state value with the condition indicative of the error in the processor.

3. The method of claim 1, further comprising:
reading at least one processor feature state value at a fuse location for processor feature states; and
comparing the at least one processor feature state value with the condition indicative of the error in the processor.

4. The method of claim 1, further comprising:
reading at least one processor feature state value at a register location for processor feature states; and
comparing the at least one processor feature state value with the condition indicative of the error in the processor.

5. The method of claim 1, wherein preventing use of the first processor comprises transitioning the first processor to a low power state.

6. The method of claim 1, wherein preventing use of the first processor comprises preventing the first processor from being registered with an operating system.

7. The method of claim 1, wherein preventing use of the first processor occurs prior to the first processor executing a process using a non-secure architecture of the first processor.

8. The method of claim 1, further comprising transitioning execution of a process scheduled for execution by the first processor to a second processor.

9. The method of claim 1, further comprising transitioning execution of a process scheduled for execution by the first processor using a non-secure architecture of the first processor to a second processor.

10. The method of claim 1, wherein determining whether a condition indicative of an error in a processor exists for the first processor comprises determining whether an enabled non-secure debug feature of the first processor and a disabled secure debug feature of the first processor exists.

11. A computing device, comprising:
a processing device configured to:
determine whether a condition indicative of an error in a processor exists for a first processor; and
prevent use of the first processor in response to determining that the condition indicative of the error in the processor exists for the first processor.

12. The computing device of claim 11, wherein the processing device is further configured to:
read at least one processor feature state value at a memory location for processor feature states; and
compare the at least one processor feature state value with the condition indicative of the error in the processor.

13. The computing device of claim 11, wherein the processing device is further configured to:
read at least one processor feature state value at a fuse location for processor feature states; and
compare the at least one processor feature state value with the condition indicative of the error in the processor.

14. The computing device of claim 11, wherein the processing device is further configured to:
read at least one processor feature state value at a register location for processor feature states; and
compare the at least one processor feature state value with the condition indicative of the error in the processor.

15. The computing device of claim 11, wherein the processing device is further configured to prevent use of the first processor by transitioning the first processor to a low power state.

16. The computing device of claim 11, wherein the processing device is further configured to prevent use of the first processor by preventing the first processor from being registered with an operating system.

17. The computing device of claim 11, wherein the processing device is further configured to prevent use of the first processor prior to the first processor executing a process using a non-secure architecture of the first processor.

18. The computing device of claim 11, wherein the processing device is further configured to transition execution of a process scheduled for execution by the first processor to a second processor.

19. The computing device of claim 11, wherein the processing device is further configured to transition execution of a process scheduled for execution by the first processor using a non-secure architecture of the first processor to a second processor.

20. The computing device of claim 11, wherein the processing device is further configured to determine whether a condition indicative of an error in a processor exists for the first processor by determining whether an enabled non-secure debug feature of the first processor and a disabled secure debug feature of the first processor exists.

21. A computing device, comprising:
means for determining whether a condition indicative of an error in a processor exists for a first processor; and
means for preventing use of the first processor in response to determining that the condition indicative of the error in the processor exists for the first processor.

22. The computing device of claim 21, further comprising:
means for reading at least one processor feature state value at a memory location for processor feature states; and
means for comparing the at least one processor feature state value with the condition indicative of the error in the processor.

23. The computing device of claim 21, further comprising:
means for reading at least one processor feature state value at a fuse location for processor feature states; and
means for comparing the at least one processor feature state value with the condition indicative of the error in the processor.

24. The computing device of claim 21, further comprising:
means for reading at least one processor feature state value at a register location for processor feature states; and
means for comparing the at least one processor feature state value with the condition indicative of the error in the processor.

25. The computing device of claim 21, wherein means for preventing use of the first processor comprises means for transitioning the first processor to a low power state.

26. The computing device of claim 21, wherein means for preventing use of the first processor comprises means for preventing the first processor from being registered with an operating system.

27. The computing device of claim 21, wherein means for preventing use of the first processor comprises means for preventing use of the first processor prior to the first processor executing a process using a non-secure architecture of the first processor.

28. The computing device of claim 21, further comprising means for transitioning execution of a process scheduled for execution by the first processor to a second processor.

29. The computing device of claim 21, further comprising means for transitioning execution of a process scheduled for execution by the first processor using a non-secure architecture of the first processor to a second processor.

30. A non-transitory, processor-readable medium having stored thereon processor-executable instructions configured to cause a processor of a computing device to perform operations comprising:
determining whether a condition indicative of an error in a processor exists for a first processor; and
preventing use of the first processor in response to determining that the condition indicative of the error in the processor exists for the first processor.
